(19) United States
(12) Patent Application Publication
(10) Pub. No.: US 2015/0253750 A1
(43) Pub. Date: Sep. 10, 2015

(54) Determination of a Parameter Device

(71) Applicant: Nokia Corporation, Espoo (FI)

(72) Inventors: Antti Johannes Eronen, Tampere (FI); Arto Juhani Lehtiniemi, Lempaala (FI); Jussi Artturi Leppanen, Lempaala (FI)

(21) Appl. No.: 14/198,500

(22) Filed: Mar. 5, 2014

(51) Int. Cl. G05B 15/02

(52) U.S. Cl. CPC G05B 15/02

(57) ABSTRACT

A method comprising receiving information indicative of a rotational input on a knob apparatus, the knob apparatus being an apparatus that comprises a knob configured to receive the rotational input, identifying a predetermined parameter directive type associated with the rotational input, the parameter directive type corresponding to a parameter of a separate apparatus that is configurable by way of a parameter directive, determining a parameter directive value adjustment based, at least in part, on the rotational input, determining the parameter directive such that the parameter directive identifies the parameter directive type and the parameter directive value adjustment, and causing the separate apparatus to configure the parameter by way of sending of the parameter directive to the separate apparatus is disclosed.

### TECHNICAL FIELD

The present application relates generally to determination of a parameter directive.

### BACKGROUND

In many circumstances, a user of an electronic apparatus may desire to interact with the electronic apparatus. For example, the user may desire to cause the electronic apparatus to perform particular predefined operations, may desire to change one or more parameters associated with the electronic apparatus, and/or the like. In such circumstances, the user may desire to interact with the electronic apparatus by way of a physical input controller.

### SUMMARY

Various aspects of examples of the invention are set out in the claims.

One or more embodiments may provide an apparatus, a computer readable medium, a non-transitory computer readable medium, a computer program product, and/or a method for receiving information indicative of a rotational input on a knob apparatus, the knob apparatus being an apparatus that comprises a knob configured to receive the rotational input, identifying a predetermined parameter directive type associated with the rotational input, the parameter directive type corresponding to a parameter of a separate apparatus that is configurable by way of a parameter directive, determining a parameter directive value adjustment based, at least in part, on the rotational input, determining the parameter directive such that the parameter directive identifies the parameter directive type and the parameter directive value adjustment, and causing the separate apparatus to configure the parameter by way of sending of the parameter directive to the separate apparatus.

One or more embodiments may provide an apparatus, a computer readable medium, a computer program product, and/or a non-transitory computer readable medium having means for receiving information indicative of a rotational input on a knob apparatus, the knob apparatus being an apparatus that comprises a knob configured to receive the rotational input, means for identifying a predetermined parameter directive type associated with the rotational input, the parameter directive type corresponding to a parameter of a separate apparatus that is configurable by way of a parameter directive, means for determining a parameter directive value adjustment based, at least in part, on the rotational input, means for determining the parameter directive such that the parameter directive identifies the parameter directive type and the parameter directive value adjustment, and means for causing the separate apparatus to configure the parameter by way of sending of the parameter directive to the separate apparatus.

In at least one example embodiment, the information indicative of the rotational input is received from at least one of a rotation sensor, an orientation sensor, or an optical sensor.

In at least one example embodiment, the knob is configured such that the knob is rotatable without limitation.

In at least one example embodiment, the knob is configured such that the knob is rotatable from a center position to a rotated position at a rotational limit.

In at least one example embodiment, the knob is configured such that the knob returns to the center position upon termination of rotation of the knob to the rotated position.

In at least one example embodiment, the knob apparatus comprises a housing and the knob, such that knob is a predominant physical aspect of the knob apparatus.

In at least one example embodiment, the knob is the predominant physical aspect of the knob apparatus by way of at least one of a physical volume of the knob apparatus, a mass of the knob apparatus, a size of the knob apparatus, a width of the knob apparatus, a circumference of the knob apparatus, or a radius of the knob apparatus.

In at least one example embodiment, the knob being the predominant aspect of the knob apparatus refers to the knob being at least seventy five percent of at least one of the physical volume of the knob apparatus, the mass of the knob apparatus, the size of the knob apparatus, the width of the knob apparatus, the circumference of the knob apparatus, or the radius of the knob apparatus.

In at least one example embodiment, the parameter directive type is associated with a parameter value constraint, the parameter value constraint being indicative of at least one of a minimum allowable value or a maximum allowable value.

In at least one example embodiment, the determination of the parameter directive value adjustment comprises determination that a value indicated by the parameter directive value adjustment complies with the parameter value constraint.

In at least one example embodiment, the parameter value constraint indicates the minimum allowable value, and the parameter directive value adjustment identifies a value that is greater than or equal to the minimum allowable value.

In at least one example embodiment, the parameter value constraint indicates the maximum allowable value, and the parameter directive value adjustment identifies a value that is less than or equal to the maximum allowable value.

In at least one example embodiment, the parameter directive type indicates at least one of a volume parameter, a temperature parameter, a fan speed parameter, a channel selection parameter, a media item rendering position parameter, or a media item selection parameter.

In at least one example embodiment, the knob apparatus comprises a display.

One or more example embodiments further perform display of a representation of the parameter directive type on the display.

One or more example embodiments further perform display of a representation of the parameter directive value adjustment.

In at least one example embodiment, the representation of the parameter directive value adjustment is indicative of a value of the parameter of the separate apparatus.

In at least one example embodiment, the representation of the parameter directive value adjustment is indicative of a change to a value of the parameter of the separate apparatus.

In at least one example embodiment, the representation of the parameter directive value adjustment is indicative of an increment to a value of the parameter of the separate apparatus.

In at least one example embodiment, the representation of the parameter directive value adjustment is indicative of a decrement to a value of the parameter of the separate apparatus.

One or more example embodiments further perform receipt of information indicative of a value of the parameter of the separate apparatus from the separate apparatus, wherein the determination of the parameter directive value adjustment is based, at least in part, on the value of the parameter of the separate apparatus.

One or more example embodiments further perform receipt of information indicative of a parameter directive type change input, and identification of a different parameter directive type based, at least in part, on the parameter directive type change input.

In at least one example embodiment, the parameter directive type change input is a press input, and the information indicative of the parameter directive type change input is received from at least one of a force sensor, a touch sensor, or a press sensor.

In at least one example embodiment, the parameter directive type change input is a high press force input.

In at least one example embodiment, the high press force input is a press input associated with a press force that exceeds a high press force threshold.

In at least one example embodiment, the parameter directive type change input is a low press force input.

In at least one example embodiment, the low press force input is a press input associated with a press force that fails to exceed a high press force threshold.

One or more example embodiments further perform receipt of information indicative of the parameter directive type from the separate apparatus, and storage of the parameter directive type in a repository, wherein the identification of the parameter directive type comprises retrieval of the parameter directive type from the repository.

One or more example embodiments further perform receipt of a parameter value constraint associated with the parameter directive type from the separate apparatus, and storage of the parameter value constraint in the repository, wherein the determination of a parameter directive value adjustment comprises retrieval of the parameter value constraint from the repository.

One or more example embodiments further perform receipt of information indicative of a programming mode enablement input, wherein the receipt of the information indicative of the parameter directive type from the separate apparatus is based, at least in part, on the programming mode enablement input.

In at least one example embodiment, the programming mode enablement input is a bending input, and the information indicative of the programming mode enablement input is received by way of at least one of a flexion sensor, a strain sensor, a flexible sensor, or a force sensor.

In at least one example embodiment, the programming mode enablement input is a touch input, and the information indicative of the programming mode enablement input is received by way of a touch display.

One or more example embodiments further perform initiation of a programming mode based, at least in part, on the programming mode enablement input, wherein the receipt of the information indicative of the parameter directive type is based, at least in part, on initiation of the programming mode, and termination of the programming mode, wherein the determination of the parameter value adjustment is based, at least in part, on the termination of the programming mode.

One or more example embodiments further perform rendering of a programming mode indicator that signifies initiation of the programming mode based, at least in part, on initiation of the programming mode.

In at least one example embodiment, the programming mode indicator is a visual indicator, and the rendering of the programming mode indicator comprises displaying of the programming mode indicator on a display.

In at least one example embodiment, the programming mode indicator is an auditory indicator, and the rendering of the programming mode indicator comprises playing of the programming mode indicator by way of a speaker.

In at least one example embodiment, the programming mode indicator is a tactile indicator, and the rendering of the programming mode indicator comprises rendering the programming mode indicator by way of a tactile feedback renderer.

In at least one example embodiment, the termination of the programming mode comprises initiation of a control mode, wherein the determination of the parameter value adjustment is based, at least in part, on the initiation of the control mode.

One or more example embodiments further perform rendering of a control mode indicator that signifies initiation of the control mode based, at least in part, on initiation of the control mode.

In at least one example embodiment, the control mode indicator is a visual indicator, and the rendering of the control mode indicator comprises displaying of the control mode indicator on a display.

In at least one example embodiment, the control mode indicator is an auditory indicator, and the rendering of the control mode indicator comprises playing of the control mode indicator by way of a speaker.

In at least one example embodiment, the control mode indicator is a tactile indicator, and the rendering of the control mode indicator comprises rendering the control mode indicator by way of a tactile feedback renderer.

In at least one example embodiment, the initiation of the programming mode comprises termination of a control mode.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus according to at least one example embodiment;

FIG. 2 is a block diagram showing apparatus communication according to at least one example embodiment;

FIGS. 3A-3B are diagrams illustrating a knob apparatus according to at least one example embodiment;

FIGS. 4A-4C are diagrams illustrating a repository according to at least one example embodiment;

FIGS. 5A-5C are diagrams illustrating a knob apparatus according to at least one example embodiment;

FIG. 6 is a flow diagram illustrating activities associated with causation of a separate apparatus to configure a parameter by way of sending of a parameter directive to the separate apparatus according to at least one example embodiment;

FIG. 7 is a flow diagram illustrating activities associated with causation of a separate apparatus to configure a parameter by way of sending of a parameter directive to the separate apparatus according to at least one example embodiment;

FIG. 8 is a flow diagram illustrating activities associated with causation of a separate apparatus to configure a parameter by way of sending of a parameter directive to the separate apparatus according to at least one example embodiment;

FIG. 9 is a flow diagram illustrating activities associated with identification of a different parameter directive type based, at least in part, on a parameter directive type change input according to at least one example embodiment;

FIG. 10 is a flow diagram illustrating activities associated with causation of a separate apparatus to configure a parameter by way of sending of a parameter directive to the separate apparatus according to at least one example embodiment; and

FIG. 11 is a flow diagram illustrating activities associated with causation of a separate apparatus to configure a parameter by way of sending of a parameter directive to the separate apparatus according to at least one example embodiment.

### DETAILED DESCRIPTION OF THE DRAWINGS

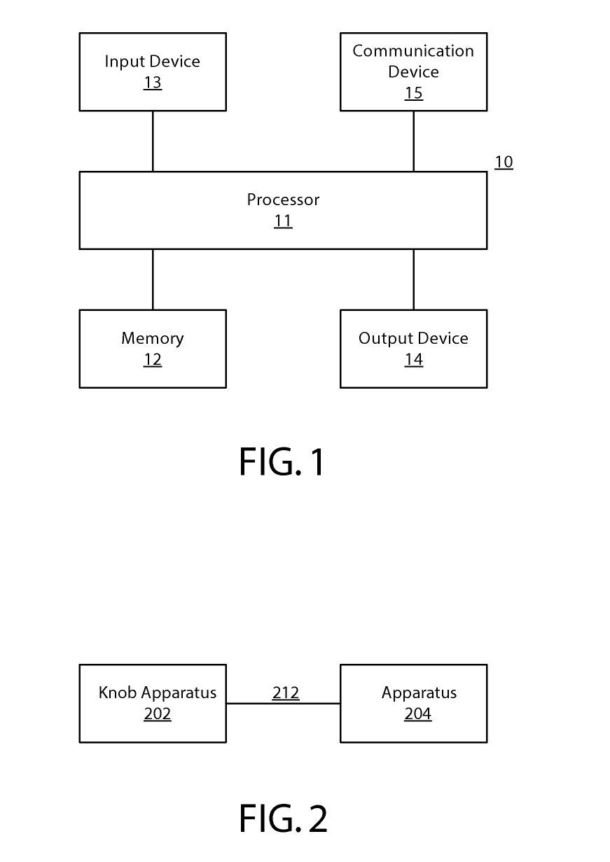

An embodiment of the invention and its potential advantages are understood by referring to FIGS. 1 through 11 of the drawings.

Some embodiments will now be described more fully hereinafter with reference to the accompanying drawings, in which some, but not all, embodiments are shown. Various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

FIG. 1 is a block diagram showing an apparatus, such as an electronic apparatus 10, according to at least one example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses may readily employ embodiments of the invention. Electronic apparatus 10 may be a personal digital assistant (PDAs), a pager, a mobile computer, a desktop computer, a television, a gaming apparatus, a laptop computer, a tablet computer, a media player, a camera, a video recorder, a mobile phone, a global positioning system (GPS) apparatus, a knob apparatus, a controller apparatus, an input apparatus, an automobile, a kiosk, an electronic table, and/or any other types of electronic systems. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries. For example, the apparatus may be, at least part of, a non-carryable apparatus, such as a large screen television, an electronic table, a kiosk, an automobile, and/or the like.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information, the causation of display may comprise displaying the information on a display comprised by the apparatus, sending the information to a separate apparatus that comprises a display, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

FIG. 2 is a block diagram showing apparatus communication according to at least one example embodiment. The example of FIG. 2 is merely an example and does not limit the scope of the claims. For example, knob apparatus count and/or apparatus count may vary, knob apparatus and/or apparatus configuration may vary, communication channels may vary, and/or the like.

In the example of FIG. 2, knob apparatus 202 communicates with apparatus 204 by way of communication channel 212. For example, knob apparatus 202 may send information to apparatus 204 by way of communication channel 212, knob apparatus 202 may receive information sent from apparatus 204 by way of communication channel 212, and/or the like. It should be understood that, even though the example of FIG. 2 illustrates a direct communication channel between knob apparatus 202 and apparatus 204, there may be intermediate apparatuses that facilitate communication between knob apparatus 202 and apparatus 204. For example, there may be one or more routers, hubs, switches, gateways, and/or the like, that are utilized in the communication channels between knob apparatus 202 and apparatus 204. In addition, there may be other separate apparatuses that knob apparatus 202 and/or apparatus 204 are in communication with. For example, knob apparatus 202 and/or apparatus 204 may be in communication with another apparatus, another knob apparatus, a separate apparatus, a different apparatus, and/or the like.

In some circumstances, a user may desire to have collaboration between apparatuses, such as between an apparatus and a separate apparatus, based on their proximity with each other. For example, it may be intuitive for a user to manage collaboration between apparatuses that are local to each other. A plurality of apparatuses may be proximate to each other based on location, availability of local communication among the apparatuses, and/or the like. For example, if the apparatuses collaborate by way of low power radio frequency communication, a radio frequency communication, near field communication, inductive communication, electric field communication, Bluetooth communication, infrared communication, local area network communication, wireless local area network communication, local port communication, input/output port communication, and/or the like, the apparatuses may be considered to be proximate with each other based, at least in part, on availability of such proximity-based communication with each other. In at least one example embodiment, an apparatus may be a phone, a tablet, a computer, a wearable apparatus, a head worn apparatus, a hand worn apparatus, an electronic apparatus, a peripheral apparatus, a host apparatus, and/or the like. In at least one example embodiment, apparatuses communicate with each other. For example, an apparatus may be an apparatus that automatically communicates with another apparatus for purposes such as identifying the apparatus, synchronizing data, exchanging status information, and/or the like. In at least one example embodiment, an apparatus retains information associated with communication with a separate apparatus. For example, the apparatus may comprise information associated with identifying, communicating with, authenticating, performing authentication with, and/or the like, the separate apparatus. In this manner, the apparatus may be privileged to perform operations in conjunction with the separate apparatus that a different apparatus may lack the privilege to perform.

In at least one example embodiment, communication based, at least in part, on short range communication is referred to as proximity-based communication. In at least one example embodiment, proximity-based communication relates to wireless communication that is associated with a short range, such as low power radio frequency communication, radio frequency communication, near field communication, inductive communication, electric field communication, Bluetooth communication, infrared communication, local area network communication, wireless local area network communication, local port communication, input/output port communication, and/or the like. In such an example, the exchange of information may be by way of the short range wireless communication between the apparatus and a separate apparatus, host apparatus, and/or the like.

In at least one example embodiment, a proximity-based communication channel is a low power radio frequency communication channel, a radio frequency communication channel, a near field communication channel, a wireless communication channel, a wireless local area network communication channel, a Bluetooth communication channel, an electric field communication channel, an inductive communication channel, an infrared communication channel, and/or the like. For example, as depicted in FIG. 2, knob apparatus 202 communicates with apparatus 204 by way of a communication channel 212. In the example of FIG. 2, communication channel 212 may be a low power radio frequency communication channel, a radio frequency communication channel, a near field communication channel, a wireless communication channel, a wireless local area network communication channel, a Bluetooth communication channel, an electric field communication channel, an inductive communication channel, an infrared communication channel, and/or the like.

In at least one example embodiment, an apparatus and a separate apparatus communicate by way of non-proximity-based communication channels. For example, as depicted in FIG. 2, knob apparatus 202 communicates with apparatus 204 by way of communication channel 212. In the example of FIG. 2, communication channel 212 may be a local area network communication channel, a wide area network communication channel, an internet communication channel, a cellular communication channel, and/or the like.

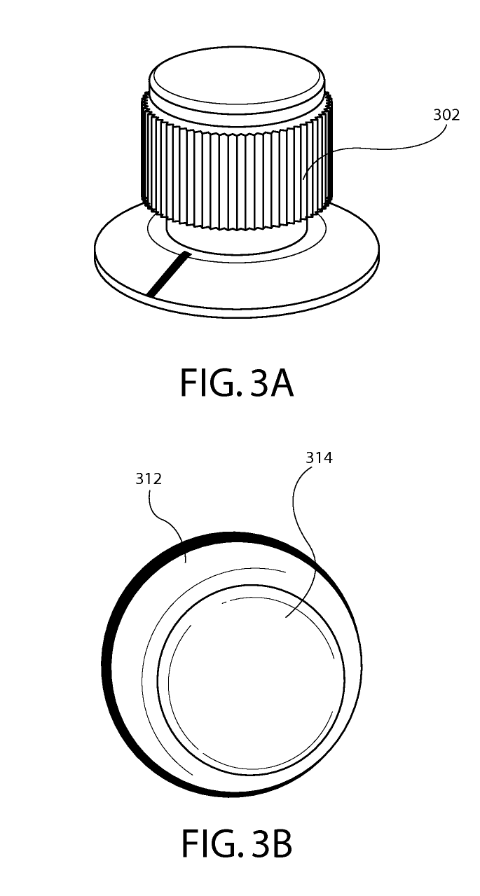

FIGS. 3A-3B are diagrams illustrating a knob apparatus according to at least one example embodiment. The examples of FIGS. 3A-3B are merely examples and do not limit the scope of the claims. For example, knob apparatus configuration may vary, knob apparatus design may vary, knob apparatus dimensions may vary, and/or the like.

In many circumstances, a user of an electronic apparatus may desire to interact with the electronic apparatus. For example, the user may desire to cause the electronic apparatus to perform certain predefined operations, may desire to change one or more parameters associated with the electronic apparatus, and/or the like. In many circumstances, the user may desire to interact with the electronic apparatus by way of a physical input controller. For example, in such circumstances, the user may desire to interact with the electronic apparatus by way of a physical button, a toggle switch, and/or the like. In at least one example embodiment, a user interacts with a separate apparatus by way of a knob apparatus. The separate apparatus may be a computer, a navigation system, a vehicle infotainment system, a phone, a tablet, and/or the like.

In this manner, a particular knob apparatus may be configured such that the knob apparatus is associated with control of one or more predefined and/or predetermined parameter directive types. As such, the knob apparatus may be utilized by a user in such a way that allows for consistent control schemes with a particular separate apparatus, a plurality of separate apparatuses, and/or the like. For example, the knob apparatus may be mountable onto a variety of surfaces, and may be configurable to control a plurality of separate apparatuses by way of a unified, simple, and intuitive knob-based control scheme. For example, the user of the knob apparatus may attach the knob apparatus to a mirror surface and utilize the apparatus to control an audio source while the user is styling the user's hair. Subsequently, the user may carry the knob apparatus to the user's vehicle, mount the knob apparatus on a dash surface within the vehicle, and utilize the knob apparatus to control the vehicle's radio, compact disc player, and/or the like. In this manner, a specific knob apparatus may be associated with a specific parameter directive type, a plurality of parameter directive types, and/or the like, such that the user may utilize a common control scheme across a variety of parameter directive types, a plurality of separate apparatuses, and/or the like. In another example, a passenger in the user's vehicle may desire to interact with and/or control the vehicle's radio, compact disc player, and/or the like, but may lack access to controls and/or a user interface that allows the passenger to do so. In such an example, the user may pass the knob apparatus to the passenger, and the passenger may utilize the knob apparatus to control the vehicle's radio, compact disc player, and/or the like.

In many circumstances, it may be desirable to configure a knob apparatus such that a user may utilize the knob apparatus in an easy and intuitive manner. In at least one example embodiment, a knob apparatus is an apparatus that comprises a knob configured to receive a rotational input, a press input, a pull input, and/or the like. For example, the knob apparatus may be configured such that a user may interact with a separate apparatus by way of grasping the knob with the user's fingertips, rotating the knob, pressing the knob, pulling the knob, and/or the like. In at least one example embodiment, a knob apparatus comprises a housing and a knob. In such an example embodiment, the knob may be a predominant physical aspect of the knob apparatus. For example, the knob may be the predominant physical aspect of the knob apparatus by way of a physical volume of the knob apparatus, a mass of the knob apparatus, a size of the knob apparatus, a width of the knob apparatus, a circumference of the knob apparatus, a radius of the knob apparatus, and/or the like. In another example, the knob is the predominant aspect of the knob apparatus by way of the knob being at least seventy five percent of the physical volume of the knob apparatus, the mass of the knob apparatus, the size of the knob apparatus, the width of the knob apparatus, the circumference of the knob apparatus, the radius of the knob apparatus, and/or the like.

In some circumstances, it may be desirable to configure a rotatable range of a knob apparatus, a type of rotation associated with rotation of the knob of the knob apparatus, and/or the like. For example, the knob of the knob apparatus may rotate smoothly, may have detents to produce discrete selections, and/or the like. In at least one example embodiment, a knob is configured such that the knob is rotatable without limitation. For example, the knob may be continuously rotatable such that the knob may be rotated clockwise and/or counterclockwise without limitation and without a discrete stopping point. In at least one example embodiment, a knob is configured such that the knob is rotatable within a rotatable range. In such an example, the rotatable range may be characterized by a clockwise rotational limit, a counterclockwise rotational limit, and/or the like. A rotational limit may be a limit, beyond which, the knob apparatus prevent further rotation. For example, the clockwise rotational limit may be a rotational limit, beyond which, the knob of the knob apparatus may be precluded from being rotated in a clockwise direction, and the counterclockwise rotational limit may be a rotational limit, beyond which, the knob of the knob apparatus may be precluded from being rotated in a counterclockwise direction. For example, the knob may be rotatable within a 180-degree rotatable range, a 270-degree rotatable range, a 345-degree rotatable range, a 720-degree rotatable range, and/or the like. In such an example, rotation of the knob to the counterclockwise rotational limit of the rotatable range may indicate a minimum value, and rotation of the knob to the clockwise rotational limit of the rotatable range may indicate a maximum value.

In some circumstances, it may be desirable to configure a knob apparatus such that a knob of the knob apparatus is in a centered position until the knob is rotated by a user. For example, the user may desire to quickly interact with a separate apparatus by way of the knob apparatus without consideration for a current position of the knob, a rotatable range of the knob, and/or the like. In at least one example embodiment, a knob is configured such that the knob is rotatable from a center position to a rotated position at a rotational limit. In such an example, the knob may be configured such that the knob returns to the center position upon termination of rotation of the knob to the rotated position. For example, a user may rotate the knob of the knob apparatus in a clockwise direction to the clockwise rotational limit. In such an example, if the user releases the knob, the knob may return to the centered position.

FIG. 3A is a diagram illustrating a knob apparatus according to at least one example embodiment. The example of FIG. 3A illustrates a knob apparatus, which comprises knob 302. In the example of FIG. 3A, the knob apparatus is configured such that a user may easily grasp knob 302 with the user's fingertips. In the example of FIG. 3A, knob 302 is a knurled knob. As can be seen in the example of FIG. 3A, knob 302 is the predominant physical aspect of the knob apparatus by way of a physical volume of the knob apparatus, a mass of the knob apparatus, a size of the knob apparatus, a width of the knob apparatus, a circumference of the knob apparatus, a radius of the knob apparatus, and/or the like. In the example of FIG. 3A, knob 302 of the knob apparatus may be continuously rotatable without limitation, may be rotatable within a rotatable range characterized by a clockwise rotational limit and/or a counterclockwise rotational limit, and/or the like. In the example of FIG. 3A, knob 302 of the knob apparatus may rotate smoothly, may have detents to produce discrete selections, and/or the like. In the example of FIG. 3A, knob 302 of the knob apparatus may be configured such that knob 302 returns to a centered position upon termination of rotation of knob 302.

FIG. 3B is a diagram illustrating a knob apparatus according to at least one example embodiment. The example of FIG. 3B illustrates a knob apparatus, which comprises knob 312 and housing 314. In the example of FIG. 3B, the knob apparatus is configured such that a user may easily grasp knob 312 with the user's fingertips. In the example of FIG. 3B, knob 312 is a ring that circumscribes housing 314, and that is rotatable around housing 314. As can be seen in the example of FIG. 3B, knob 312 is the predominant physical aspect of the knob apparatus by way of a physical volume of the knob apparatus, a mass of the knob apparatus, a size of the knob apparatus, a width of the knob apparatus, a circumference of the knob apparatus, a radius of the knob apparatus, and/or the like. For example, as can be seen, the radius of knob 312 is greater than the radius of housing 314. As such, knob 312 may be the predominant physical aspect of the knob apparatus by way of the radius of the knob apparatus, the circumference of the knob apparatus, the width of the knob apparatus, the size of the knob apparatus, and/or the like. In the example of FIG. 3B, knob 312 of the knob apparatus may be continuously rotatable without limitation, may be rotatable within a rotatable range characterized by a clockwise rotational limit and/or a counterclockwise rotational limit, and/or the like. In the example of FIG. 3B, knob 312 of the knob apparatus may rotate smoothly, may have detents to produce discrete selections, and/or the like. In the example of FIG. 3B, knob 312 of the knob apparatus may be configured such that knob 312 returns to a centered position with respect to housing 314 upon termination of rotation of knob 312.

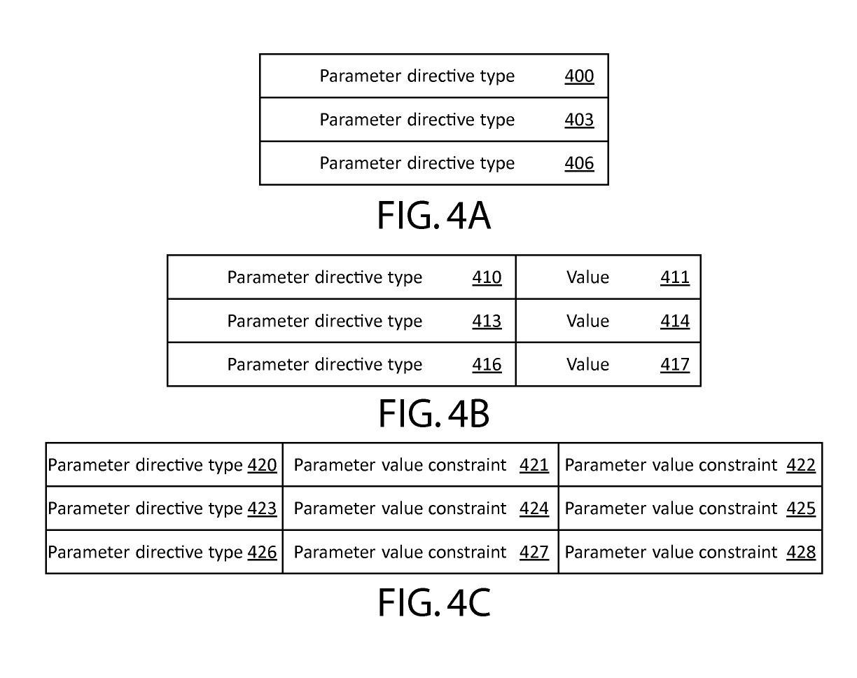

FIGS. 4A-4C are diagrams illustrating a repository according to at least one example embodiment. The examples of FIGS. 4A-4C are merely examples and do not limit the scope of the claims. For example, repository configuration may vary, repository content may vary, repository structure may vary, associations between parameter directive type, parameter value constraint, and/or value may vary, and/or the like.

As discussed previously, in many circumstances, a user may desire to interact with an electronic apparatus by way of a knob apparatus. In such an example, it may be desirable to configure the knob apparatus such that the knob apparatus may interact with the electronic apparatus in response to a rotational input associated with the knob apparatus, control one or more parameters associated with the electronic apparatus based, at least in part, on the rotational input, and/or the like. In at least one example embodiment, a knob apparatus receives information indicative of a rotational input on the knob apparatus. The information indicative of the rotational input may be received from a rotation sensor, an orientation sensor, or an optical sensor, and/or the like. For example, the user may interact with a separate apparatus by way of rotating the knob apparatus, rotating the knob of the knob apparatus, and/or the like.

In many circumstances, a user may desire to interact with the separate apparatus in a particular manner, may desire to change a specific parameter associated with the separate apparatus, and/or the like. As such, it may be desirable to determine a specific type of parameter, a specific parameter, and/or the like, to change based, at least in part, on the rotational input. In at least one example embodiment, a knob apparatus identifies a predetermined parameter directive type associated with the rotational input. In such an example embodiment, the parameter directive type may correspond to a parameter of the separate apparatus that is configurable by way of a parameter directive. The parameter may be any user definable variable, option, configuration, and/or the like that is associated with the separate apparatus. In such an example, the parameter directive may be a directive that causes the separate apparatus to modify the parameter, change the parameter, set the parameter to a specific value, and/or the like. In at least one example embodiment, a parameter is of a specific type, as indicated by the parameter directive type. For example, the parameter directive type may indicate that the parameter is a volume parameter, a radio frequency parameter, a temperature parameter, a fan speed parameter, a channel selection parameter, a media item rendering position parameter, a media item selection parameter, and/or the like.

In some circumstances, in order to facilitate interaction with a separate apparatus, control of a specific parameter associated with the separate apparatus, and/or the like, it may be desirable to receive information from the separate apparatus that indicates a type of a user definable parameter, a type of the parameter that may be modified based, at least in part, on a rotational input associated with the knob apparatus, and/or the like. In at least one example embodiment, a knob apparatus receives information indicative of a parameter directive type from a separate apparatus. For example, the information received from the separate apparatus may indicate that the parameter is a volume parameter, a radio frequency parameter, a temperature parameter, a fan speed parameter, a channel selection parameter, a media item rendering position parameter, a media item selection parameter, a navigation related parameter, and/or the like. For example, the parameter may be a navigation related parameter, such as a navigation display mode parameter, a point of interest selection parameter, a destination selection parameter, a navigation search input parameter, and/or the like. In such an example, a user may utilize the knob apparatus for purposes relating to selection of a navigation route, browsing through a list of point of interest destinations, and/or the like. In such circumstances, it may be desirable to store such an indication of the parameter directive type. For example, in order to facilitate modification of a specific parameter directive type, it may be desirable to store information indicative of the specific parameter directive type for subsequent references, retrieval, and/or the like. In at least one example embodiment, a knob apparatus stores a parameter directive type in a repository. The repository may be a data structure, a database, a table, a linked list, a stack, an array, and/or the like. The repository may be stored in at least one memory comprised by the knob apparatus, stored by way of a separate apparatus, and/or the like. In such an example embodiment, the identification of the parameter directive type may comprise retrieval of the parameter directive type from the repository. In this manner, the knob apparatus may identify the parameter directive type by way of retrieval of information indicative of the parameter directive type from the repository prior to receipt of information indicative of a rotational input, subsequent to receipt of information indicative of a rotational input, and/or the like.

In many circumstances, a user may desire to control more than one discrete parameter, parameters associated with multiple parameter directive types, and/or the like. For example, the user may desire to control a temperature parameter and, subsequently, to control a radio frequency parameter. In such circumstances, it may be desirable to configure the knob apparatus such that a user of the knob apparatus may switch between parameter directive types, terminate control of a parameter associated with a parameter directive type, initiate control of a different parameter associated with another parameter directive type, and/or the like. In at least one example embodiment, a knob apparatus receives information indicative of a parameter directive type change input. In such an example embodiment, the knob apparatus may identify a different parameter directive type based, at least in part, on the parameter directive type change input. In at least one example embodiment, the parameter directive type change input is a press input. In such an example embodiment, the information indicative of the parameter directive type change input may be received from a force sensor, a touch sensor, a press sensor, a toggle sensor, and/or the like.

In some circumstances, it may be desirable to configure a knob apparatus such that the knob apparatus may distinguish between particular types of press inputs. For example, a press input may be a low press force input, a high press force input, a short duration press input, a long duration press input, and/or the like. In at least one example embodiment, a parameter directive type change input is a high press force input. The high press force input may be a press input associated with a press force that exceeds a high press force threshold. For example, the information indicative of the parameter directive type change input may be received from a force sensor that indicates a press force associated with the parameter directive type change input. In this manner, a parameter directive type change input associated with a press force that exceeds a high press force threshold may be a high press force input, and a parameter directive type change input associated with a press force that fails to exceed the high press force threshold may be a low press force input. In another example, the high press force input may be a press input associated with a press force that exceeds a low press force threshold. In such an example, a parameter directive type change input associated with a press force that exceeds a low press force threshold may be a high press force input, and a parameter directive type change input associated with a press force that fails to exceed the low press force threshold may be a low press force input.

FIG. 4A is a diagram illustrating a repository according to at least one example embodiment. The example of FIG. 4A depicts a repository that comprises information indicative of parameter directive types 400, 403, and 406. Each of parameter directive types 400, 403, and 406 may indicate that a specific parameter is a volume parameter, a radio frequency parameter, a temperature parameter, a fan speed parameter, a channel selection parameter, a media item rendering position parameter, a media item selection parameter, and/or the like. For example, one or more of parameter directive types 400, 403, or 406 may be predetermined parameter directive types caused to be stored in the repository. In another example, a knob apparatus may have received information indicative of one or more of parameter directive types 400, 403, or 406. In such an example, the knob apparatus may have subsequently caused storage of information indicative of the parameter directive type in the repository. The repository may be a data structure, a database, a table, a linked list, a stack, an array, and/or the like. In the example of FIG. 4A, a user of a knob apparatus may toggle between control of parameter directive types 400, 403, and 406 by way of a parameter directive type change input. For example, a rotational input associated with the knob apparatus may cause modification to parameter directive type 400. In such an example, the knob apparatus may receive information indicative of a parameter directive type change input. In such an example, subsequent to the receipt of the information indicative of the parameter directive type change input, a rotational input associated with the knob apparatus may cause modification to parameter directive type 403, parameter directive type 406, and/or the like.

In order to facilitate modification of a particular parameter to a specific value, it may be desirable to modify the specific parameter by way of incrementing a value associated with the parameter, decrementing a value associated with the parameter, changing the value associated with the parameter to a different value, and/or the like. In at least one example embodiment, a knob apparatus causes modification to a specific parameter by way of a parameter directive value adjustment. In such an example embodiment, the knob apparatus may determine a parameter directive value adjustment based, at least in part, on a rotational input. For example, the parameter directive value adjustment may be based, at least in part, on a magnitude of the rotational input, a direction of the rotational input, a degree of rotation associated with the rotational input, a rotated position of the knob of the knob apparatus, an duration of time that the knob of the knob apparatus is held at the rotated position, and/or the like.

As discussed previously, in many circumstances, it may be desirable to determine a parameter directive value adjustment based, at least in part, on a specific value of a particular parameter associated with a separate apparatus. For example, in such circumstances, a rotational input may cause modification to the value of the parameter relative to a current value of the parameter, in relation to the value of the parameter at a time prior to receipt of the rotational input, and/or the like. In at least one example embodiment, an apparatus receives information indicative of a value of a parameter of a separate apparatus from the separate apparatus. In such an example embodiment, the determination of the parameter directive value adjustment may be based, at least in part, on the value of the parameter of the separate apparatus. For example, a parameter directive type may indicate that a particular parameter is a radio frequency parameter, and the value of the parameter may indicate a radio frequency of 97.9 MHz. In such an example, a user may desire to change the radio frequency parameter in order to begin listening to a different radio broadcast associated with a different radio frequency, for example, 104.5 MHz. As such, subsequent to receipt of a rotational input, the determination of the parameter directive value adjustment may be based, at least in part, on the current value of the radio frequency parameter, 97.9 MHz. In this manner, the parameter directive value adjustment may indicate an adjustment to 104.5 MHz, may indicate a 6.6 MHz increment to the value of the radio frequency parameter, and/or the like, such that the value of the radio frequency parameter changes to 104.5 MHz.

In some circumstances, it may be desirable to allow additional types of inputs to be performed by way of a knob apparatus. For example, as previously discussed, it may be desirable to configure the knob apparatus such that a user of the knob apparatus may perform a press input, a pull input, and/or the like, in addition to a rotational input. In such an example, it may be desirable to associate different types of press inputs with one or more additional operations, directives, and/or the like. In at least one example embodiment, a knob apparatus received information indicative of a low press force input. In such an example, the knob apparatus may determine a parameter directive value adjustment that indicates toggling between two or more states of a parameter, adjustment to a value of a parameter, and/or the like. For example, the parameter directive type may indicate that the parameter is a playback parameter, and receipt of a low press force input may indicate a desire for the knob apparatus to cause change the value of the playback parameter such that playback of a media item is initiated, terminated, suspended, resumed, and/or the like. The low press force input may be a press input associated with a press force which fails to exceed a high press force threshold, which fails to exceed a low press force threshold, and/or the like.

FIG. 4B is a diagram illustrating a repository according to at least one example embodiment. The example of FIG. 4B depicts a repository that comprises information indicative of parameter directive types 410, 413, and 416, which are associated with values 411, 414, and 417, respectively. Each of parameter directive types 410, 413, and 416 may indicate that a specific parameter is a volume parameter, a radio frequency parameter, a temperature parameter, a fan speed parameter, a channel selection parameter, a media item rendering position parameter, a media item selection parameter, and/or the like. For example, one or more of parameter directive types 410, 413, and 416 may be predetermined parameter directive types caused to be stored in the repository. In another example, a knob apparatus may have received information indicate of one or more of parameter directive types 410, 413, and 416. In such an example, the knob apparatus may have subsequently caused storage of information indicative of the parameter directive type in the repository. The repository may be a data structure, a database, a table, a linked list, a stack, an array, and/or the like. In the example of FIG. 4B, a user of a knob apparatus may toggle between control of parameter directive types 410, 413, and 416 by way of a parameter directive type change input. For example, a rotational input associated with the knob apparatus may cause modification to parameter directive type 410. In such an example, the knob apparatus may receive information indicative of a parameter directive type change input. In such an example, subsequent to the receipt of the information indicative of the parameter directive type change input, a rotational input associated with the knob apparatus may cause modification to parameter directive type 413, parameter directive type 416, and/or the like.

In the example of FIG. 4B, values 411, 414, and 417 indicate a specific value associated with parameter directive types 410, 413, and 416, respectively. For example, the knob apparatus associated with the repository illustrated in the example of FIG. 4B may have received information indicative of each of values 411, 414, and 417, and caused storage of each of values 411, 414, and 417 such that the values are associated with the respective parameter directive type. For example, parameter directive type 410 may indicate that a parameter is a radio frequency parameter, and value 411 may indicate that the value of the radio frequency parameter is 97.9 MHz. In another example, parameter directive type 413 may indicate that a parameter is a fan speed parameter, and value 414 may indicate that the value of the radio frequency parameter is a medium fan speed.

In many circumstances, it may be desirable to limit an adjustable range associated with a particular parameter directive type, associated with a particular parameter, associated with a value of a specific parameter, and/or the like. For example, a particular parameter directive type may be associated with inherent limitations, an operational maximum value, an operational minimum value, and/or the like. For example, an air conditioner may be configured such that the air conditioner may condition the air in a particular volume to a minimum temperature of 60-degrees Fahrenheit, and a maximum temperature of 110-degrees Fahrenheit. In such an example, it may be desirable to cause modification of a temperature parameter to a value that is within the range of temperatures between the minimum temperature of 60-degrees Fahrenheit and the maximum temperature of 110-degrees Fahrenheit.

In at least one example embodiment, a parameter directive type is associated with a parameter value constraint. The parameter value constraint may be indicative of a minimum allowable value, a maximum allowable value, and/or the like. In such an example embodiment, the determination of the parameter directive value adjustment may comprise determination that a value indicated by the parameter directive value adjustment complies with the parameter value constraint. For example, the parameter value constraint may indicate the minimum allowable value, and the parameter directive value adjustment identifies a value that is greater than or equal to the minimum allowable value. In such an example, the parameter directive value adjustment complies with the parameter value constraint. In another example, the parameter value constraint may indicate the maximum allowable value, and the parameter directive value adjustment identifies a value that is less than or equal to the maximum allowable value. In such an example, the parameter directive value adjustment complies with the parameter value constraint. The parameter value constraint may be a predetermined parameter value constraint associated with a particular parameter directive type, may be received from a separate apparatus, and/or the like.

In order to facilitate implementation of such constraints on parameter directive value adjustments, it may be desirable to cause storage of one or more parameter value constraints such that the parameter value constraints are associated with the applicable parameter directive type. In at least one example embodiment, a knob apparatus causes storage of a parameter value constraint in a repository. In such an example embodiment, the determination of a parameter directive value adjustment may comprise retrieval of the parameter value constraint from the repository.

FIG. 4C is a diagram illustrating a repository according to at least one example embodiment. FIG. 4C is a diagram illustrating a repository according to at least one example embodiment. The example of FIG. 4C depicts a repository that comprises information indicative of parameter directive types 420, 423, and 426, which are associated with parameter value constraints 421 and 422, parameter value constraints 424 and 425, and parameter value constraints 427 and 428, respectively. Each of parameter directive types 420, 423, and 426 may indicate that a specific parameter is a volume parameter, a radio frequency parameter, a temperature parameter, a fan speed parameter, a channel selection parameter, a media item rendering position parameter, a media item selection parameter, and/or the like. For example, one or more of parameter directive types 420, 423, and 426 may be predetermined parameter directive types caused to be stored in the repository. In another example, a knob apparatus may have received information indicate of one or more of parameter directive types 420, 423, and 426. In such an example, the knob apparatus may have subsequently caused storage of information indicative of the parameter directive type in the repository. The repository may be a data structure, a database, a table, a linked list, a stack, an array, and/or the like. In the example of FIG. 4C, a user of a knob apparatus may toggle between control of parameter directive types 420, 423, and 426 by way of a parameter directive type change input. For example, a rotational input associated with the knob apparatus may cause modification to parameter directive type 420. In such an example, the knob apparatus may receive information indicative of a parameter directive type change input. In such an example, subsequent to the receipt of the information indicative of the parameter directive type change input, a rotational input associated with the knob apparatus may cause modification to parameter directive type 423, parameter directive type 426, and/or the like.

In the example of FIG. 4C, parameter value constraints 421, 424, and 427 indicate a minimum allowable value associated with parameter directive types 420, 423, and 426, respectively. In the example of FIG. 4C, parameter value constraints 422, 425, and 428 indicate a maximum allowable value associated with parameter directive types 420, 423, and 426, respectively. In this manner, a value associated with parameter directive type 420 may fall between parameter values constraints 421 and 422, a value associated with parameter directive type 423 may fall between parameter values constraints 424 and 425, and a value associated with parameter directive type 426 may fall between parameter values constraints 427 and 428. For example, parameter directive type 420 may indicate that a parameter is a radio frequency parameter, parameter value constraint 421 may indicate a minimum allowable value of 85.0 MHz, and parameter value constraint 422 may indicate a maximum allowable value of 107.5 MHz. In this manner, a value associated with parameter directive type 420, a radio frequency parameter, may be limited to a radio frequency that is between 85.0 and 107.5 MHz. As such, a parameter directive value adjustment that results in the value associated with parameter directive type 420 being changed to a value that is within the range between 85.0 and 107.5 MHz complies with parameter value constraint 421 and/or 422. Similarly, a parameter directive value adjustment that results in the value associated with parameter directive type 420 being changed to a value that is beyond the range between 85.0 and 107.5 MHz fails to comply with parameter value constraint 421 and/or 422

In many circumstances, a user may desire to configure a knob apparatus such that the knob apparatus operates in a particular manner, controls a specific parameter directive type, modifies an indicated parameter type within the bounds of one or more parameter value constraints, and/or the like. As such, it may be desirable to configure the knob apparatus such that a user of the knob apparatus may modify one or more attributes associated with the knob apparatus, the parameter directive type, the parameter value constraints, and/or the like.

In order to distinguish between normal operation of a knob apparatus an any programming functionality that may be accessible by a user of the knob apparatus, it may be desirable to explicitly differentiate between a control mode of the knob apparatus and a programming mode of the knob apparatus. In at least one example embodiment, an apparatus initiates a programming mode based, at least in part, on a programming mode enablement input. In such an example embodiment, the receipt of the information indicative of the parameter directive type may be based, at least in part, on initiation of the programming mode. For example, a knob apparatus may receive information indicative of a programming mode enablement input. In such an example, the receipt of the information indicative of the parameter directive type from the separate apparatus may be based, at least in part, on the programming mode enablement input.

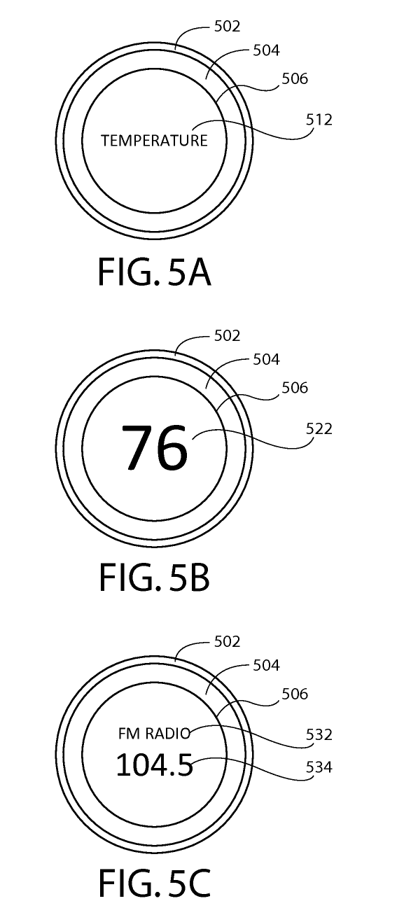

The programming mode enablement input may be an input that indicates that a user of the knob apparatus desires to program one or more aspects associated with operation of the knob apparatus, interaction with a separate apparatus associated with the knob apparatus, and/or the like. In at least one example embodiment, the programming mode enablement input is a bending input. In such an example embodiment, the information indicative of the programming mode enablement input may be received by way of at least one of a flexion sensor, a strain sensor, a flexible sensor, or a force sensor. In at least one example embodiment, the programming mode enablement input is a touch input. In such an example embodiment, the information indicative of the programming mode enablement input may be received by way of a touch display, similar as described regarding FIGS. 5A-5C.

In order to ensure that a user intends to cause initiation of the programming mode, prevent unauthorized users from causing initiation of the programming mode, and/or the like, it may be desirable to configure the programming mode enablement input such that the programming mode enablement input is not prone to accidental input, requires more than a simple input, and/or the like. For example, the programming mode enablement input may be a series of bending inputs that correspond with a predetermined pattern of bending, flexion, force, and/or the like. In another example, the programming mode enablement input may be a series of touch inputs that indicate a predetermined code, password, and/or the like. In this manner, the programming mode enablement input may be configured such that knowledge of the programming mode enablement input indicates authorization to cause initiation of the programming mode of the knob apparatus.

In order to convey to a user of a knob apparatus that the apparatus has initiated the aforementioned programming mode, it may be desirable to cause rendering of one or more programming mode indicators that signify initiation of the programming mode. In at least one example embodiment, a knob apparatus causes rendering of a programming mode indicator that signifies initiation of the programming mode. In such an example embodiment, the rendering of a programming mode indicator may be based, at least in part, on initiation of the programming mode, termination of a control mode, and/or the like. For example, the programming mode indicator may be a visual indicator. In such an example, the rendering of the programming mode indicator may comprise displaying of the programming mode indicator on a display. In another example, the programming mode indicator may be an auditory indicator. In such an example, the rendering of the programming mode indicator may comprise playing of the programming mode indicator by way of a speaker. In yet another example, the programming mode indicator may be a tactile indicator. In such an example, the rendering of the programming mode indicator may comprise rendering the programming mode indicator by way of a tactile feedback renderer.

Upon completion of any programming activities associated with the knob apparatus, a user of the knob apparatus may desire to cause termination of the programming mode such that the user may resume non-programming related operations associated with the knob apparatus. In this manner, it may be desirable to terminate the programming mode and/or to initiate a control mode associated with the knob apparatus. In at least one example embodiment, a knob apparatus terminates a programming mode. In such an example embodiment, the determination of the parameter value adjustment may be based, at least in part, on the termination of the programming mode. In this manner, the adjustment of a value associated with a particular parameter may be initiated in the control mode, and may be precluded from initiation in the programming mode. In at least one example embodiment, termination of the programming mode comprises initiation of a control mode, wherein the determination of the parameter value adjustment is based, at least in part, on the initiation of the control mode. Similarly, for example, initiation of the programming mode may comprise termination of the control mode. In this manner, the knob apparatus may switch from a control mode to a programming mode, and revert back to the control mode upon termination of the programming mode.

In order to convey to a user of a knob apparatus that the apparatus has initiated the aforementioned control mode, it may be desirable to cause rendering of one or more control mode indicators that signify initiation of the control mode. In at least one example embodiment, a knob apparatus causes rendering of a control mode indicator that signifies initiation of the control mode. In such an example embodiment, the rendering of a control mode indicator may be based, at least in part, on initiation of the control mode, termination of a programming mode, and/or the like. For example, the control mode indicator may be a visual indicator. In such an example, the rendering of the control mode indicator may comprise displaying of the control mode indicator on a display. In another example, the control mode indicator may be an auditory indicator. In such an example, the rendering of the control mode indicator may comprise playing of the control mode indicator by way of a speaker. In yet another example, the control mode indicator may be a tactile indicator. In such an example, the rendering of the control mode indicator may comprise rendering the control mode indicator by way of a tactile feedback renderer.

In order to facilitate interaction with the separate apparatus, modification of a value of a parameter that may be associated with the separate apparatus, and/or the like, it may be desirable to configure a knob apparatus such that the knob apparatus may cause the separate apparatus to perform one or more operations in conformance with such interactions, modifications, and/or the like. In at least one example embodiment, a knob apparatus determines a parameter directive such that the parameter directive identifies the parameter directive type and the parameter directive value adjustment, and sending the parameter directive to the separate apparatus. In this manner, the knob apparatus causes the separate apparatus to configure the parameter in conformance with the parameter directive by way of sending of the parameter directive to the separate apparatus. In at least one example embodiment, a parameter directive is a directive that instructs a separate apparatus to perform a particular set of operations that are associated with the directive. In at least one example embodiment, the parameter directive identifies at least one operation of the set of operations. For example, the parameter directive may be a directive that instructs the separate apparatus to configure the parameter directive type indicated in the directive based, at least in part, on the parameter directive value adjustment indicated in the directive.

FIGS. 5A-5C are diagrams illustrating a knob apparatus according to at least one example embodiment. The examples of FIGS. 5A-5C are merely examples and do not limit the scope of the claims. For example, knob apparatus configuration may vary, knob apparatus design may vary, knob apparatus dimensions may vary, display content may vary, and/or the like.

In many circumstances, a user of a knob apparatus may desire to perceive visual feedback associated with modification of a parameter directive type, setting of a parameter, adjusting a value associated with a parameter of a particular parameter directive type, and/or the like. In this manner, it may be desirable to configure a knob apparatus such that the knob apparatus may convey information associated with modification of a parameter directive type, setting of a parameter, adjusting a value associated with a parameter of a particular parameter directive type, and/or the like to the user of the knob apparatus. In at least one example embodiment, a knob apparatus comprises a display. In such an example embodiment, the knob apparatus may cause display of a representation of a parameter directive type, a representation of a value of a parameter associated with a separate apparatus, a representation of a parameter directive value adjustment, and/or the like, on the display. For example, the representation of the parameter directive value adjustment may be indicative of a value of the parameter of the separate apparatus. In another example, the representation of the parameter directive value adjustment may be indicative of a change to a value of the parameter of the separate apparatus. In such an example, the representation of the parameter directive value adjustment may be indicative of an increment to a value of the parameter of the separate apparatus, a decrement to the value of the parameter of the separate apparatus, and/or the like. In this manner, the user of the knob apparatus may perceive visual information that indicates a particular parameter directive type that may be modified by way of a rotational input, a value of a particular parameter that may be modified by way of the rotational input, one or more parameter value constraints that restricts adjustment of a particular parameter directive type to values within the allowable adjustment range, and/or the like.

In some circumstances, it may be desirable to configure a knob apparatus such that the knob apparatus may utilize one or more displays that may be associated with a separate apparatus. For example, the knob apparatus may display of visual information on a display comprised by the knob apparatus, may cause display of visual information on another display comprised by the separate apparatus, and/or the like. In such an example, the knob apparatus may cause display of visual information, a representation of a parameter directive type, a representation of a value of a parameter associated with a separate apparatus, a representation of a parameter directive value adjustment, and/or the like, on the other display that is comprised by the separate apparatus. For example, the knob apparatus may send information indicative of the visual information, etc. to the separate apparatus such that the separate apparatus causes display of the visual information on a display that is comprised by the separate apparatus. For example, a knob apparatus may be placed on a display surface. In such an example, the knob apparatus may cause the separate apparatus to display visual information such that the visual information is displayed relative to the knob apparatus, proximate to the knob apparatus, and/or the like. For example, a display comprised by the knob apparatus may display the value of a temperature parameter, and the separate apparatus may be caused to display visual information indicative of a temperature scale associated with the temperature parameter.

FIG. 5A is a diagram illustrating a knob apparatus according to at least one example embodiment. The example of FIG. 5A illustrates a knob apparatus similar to the knob apparatus illustrated in the example of FIG. 3B. In the example of FIG. 5A, the depicted knob apparatus comprises knob 502, housing 504, and display 506. As depicted, display 506 is coupled to housing 504. Housing 504 may be stationary such that housing 504 fails to rotate in unison with knob 502. In this manner, display 506 may be perceivable by a user in the depicted upright orientation notwithstanding rotation of knob 502. As can be seen, representation 512 is displayed on display 506.

In the example of FIG. 5A representation 512 is a representation of a parameter directive type. As can be seen, representation 512 comprises the text “TEMPERATURE”, which may indicate that the parameter directive type represented by representation 512 is a temperature parameter. In this manner, representation 512 may indicate to a user of the knob apparatus that a rotational input received by way of knob 502 may cause adjustment to the temperature parameter, setting of the temperature parameter to a different value, and/or the like.

FIG. 5B is a diagram illustrating a knob apparatus according to at least one example embodiment. The example of FIG. 5B illustrates a knob apparatus that corresponds with the knob apparatus of FIG. 5A. For example, FIG. 5B may illustrate the knob apparatus of FIG. 5A subsequent to receipt of a rotational input by way of knob 502, during adjustment of the value of a parameter, and/or the like. As can be seen, representation 522 is displayed on display 506.

In the example of FIG. 5B representation 522 is a representation of a value of a parameter. As can be seen, representation 522 comprises the text “76”, which may indicate that the value of the temperature parameter is 76-degrees Fahrenheit. In this manner, representation 522 may indicate to a user of the knob apparatus that the rotational input received by way of knob 502 may cause adjustment to the temperature parameter from the current temperature value of 76-degrees Fahrenheit. Alternatively, the knob apparatus may have caused display of representation 522 based, at least in part, on receipt of a rotational input that indicated a user desire to adjust the value of the temperature parameter from a different temperature to 76-degrees Fahrenheit.

FIG. 5C is a diagram illustrating a knob apparatus according to at least one example embodiment. The example of FIG. 5C illustrates a knob apparatus that corresponds with the knob apparatus of FIG. 5A. For example, FIG. 5C may illustrate the knob apparatus of FIG. 5A subsequent to receipt of a parameter directive change input associated with knob 502, housing 504, and/or display 506. As can be seen, representations 532 and 534 are displayed on display 506.

In the example of FIG. 5C representation 532 is a representation of a parameter directive type. As can be seen, representation 532 comprises the text “FM RADIO”, which may indicate that the parameter directive type represented by representation 532 is a radio frequency parameter. In this manner, representation 532 may indicate to a user of the knob apparatus that a rotational input received by way of knob 502 may cause adjustment to the radio frequency parameter, setting of the radio frequency parameter to a different value, and/or the like.

In the example of FIG. 5C representation 534 is a representation of a value of a parameter. As can be seen, representation 534 comprises the text “104.5”, which may indicate that the value of the radio frequency parameter is 104.5 MHz. In this manner, representation 534 may indicate to a user of the knob apparatus that the rotational input received by way of knob 502 may cause adjustment to the temperature parameter from the current radio frequency value of 104.5 MHz. Alternatively, the knob apparatus may have caused display of representation 534 based, at least in part, on receipt of a rotational input that indicated a user desire to adjust the value of the temperature parameter from a different radio frequency to 104.5 MHz.

In some circumstances, it may be desirable to configure a knob apparatus such that the knob apparatus is primarily an input apparatus, a control apparatus, and/or the like. In at least one example embodiment, a knob apparatus fails to comprise an environmental sensor, such as a temperature sensor, an air pressure sensor, an altitude sensor, a smoke sensor, a heat sensor, a carbon monoxide sensor, and/or the like.

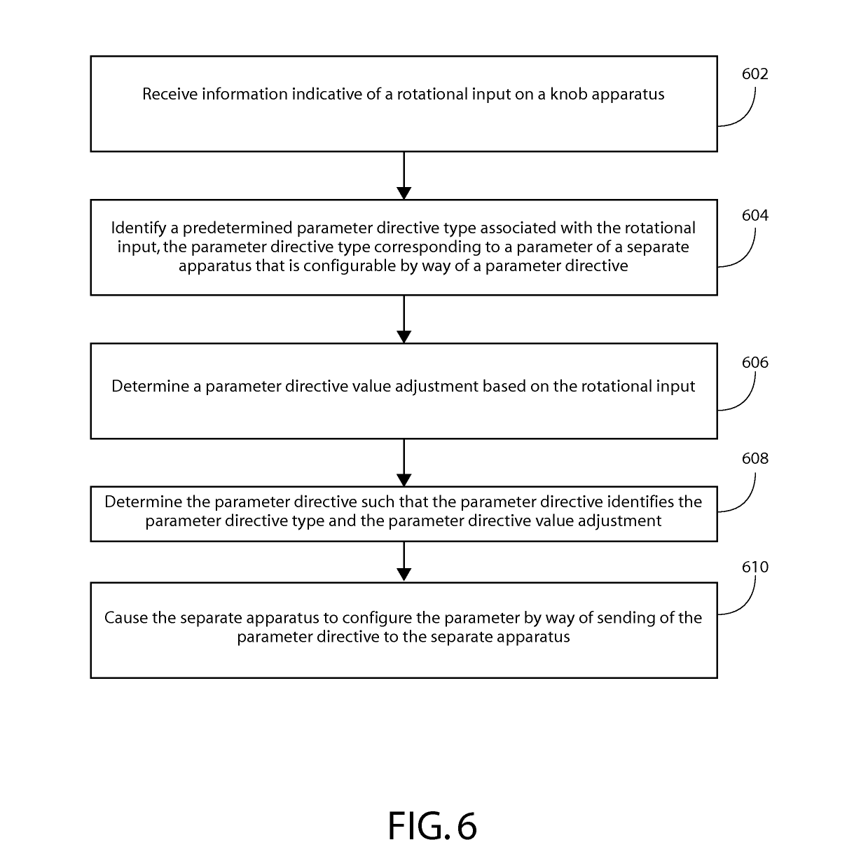

FIG. 6 is a flow diagram illustrating activities associated with causation of a separate apparatus to configure a parameter by way of sending of a parameter directive to the separate apparatus according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

At block 602, the apparatus receives information indicative of a rotational input on a knob apparatus. In at least one example embodiment, the knob apparatus is an apparatus that comprises a knob configured to receive a rotational input. The receipt, the rotational input, the knob apparatus, and the knob may be similar as described regarding FIG. 2, FIGS. 3A-3B, and FIGS. 5A-5C.

At block 604, the apparatus identifies a predetermined parameter directive type associated with the rotational input. In at least one example embodiment, the parameter directive type corresponds to a parameter of a separate apparatus that is configurable by way of a parameter directive. The identification, the parameter directive type, the parameter, the separate apparatus, and the parameter directive may be similar as described regarding FIG. 2, FIGS. 3A-3B, FIGS. 4A-4C, and FIGS. 5A-5C.

At block 606, the apparatus determines a parameter directive value adjustment based, at least in part, on the rotational input. The determination and the parameter directive value adjustment may be similar as described regarding FIGS. 3A-3B, FIGS. 4A-4C, and FIGS. 5A-5C.

At block 608, the apparatus determines the parameter directive such that the parameter directive identifies the parameter directive type and the parameter directive value adjustment. The determination may be similar as described regarding FIGS. 3A-3B, FIGS. 4A-4C, and FIGS. 5A-5C.

At block 610, the apparatus causes the separate apparatus to configure the parameter by way of sending of the parameter directive to the separate apparatus. The sending of the parameter directive and the causation of configuration may be similar as described regarding FIG. 2, FIGS. 3A-3B, FIGS. 4A-4C, and FIGS. 5A-5C.

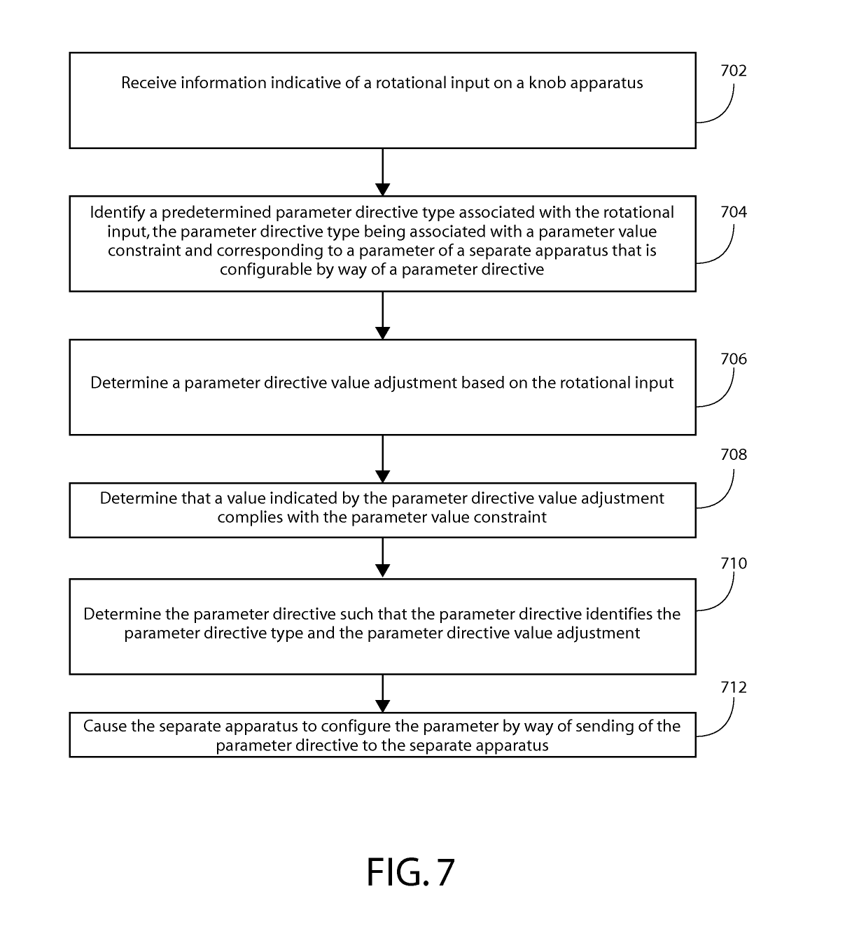

FIG. 7 is a flow diagram illustrating activities associated with causation of a separate apparatus to configure a parameter by way of sending of a parameter directive to the separate apparatus according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

As discussed previously, in many circumstances, it may be desirable to determine that a value indicated by a parameter directive value adjustment complies with a parameter value constraint.

At block 702, the apparatus receives information indicative of a rotational input on a knob apparatus. In at least one example embodiment, the knob apparatus is an apparatus that comprises a knob configured to receive a rotational input. The receipt, the rotational input, the knob apparatus, and the knob may be similar as described regarding FIG. 2, FIGS. 3A-3B, and FIGS. 5A-5C.

At block 704, the apparatus identifies a predetermined parameter directive type associated with the rotational input. In at least one example embodiment, the parameter directive type corresponds to a parameter of a separate apparatus that is configurable by way of a parameter directive. In at least one example embodiment, the parameter directive type is associated with a parameter value constraint. The identification, the parameter directive type, the parameter, the separate apparatus, the parameter directive, and the parameter value constraint may be similar as described regarding FIG. 2, FIGS. 3A-3B, FIGS. 4A-4C, and FIGS. 5A-5C.

At block 706, the apparatus determines a parameter directive value adjustment based, at least in part, on the rotational input. The determination and the parameter directive value adjustment may be similar as described regarding FIGS. 3A-3B, FIGS. 4A-4C, and FIGS. 5A-5C.

At block 708, the apparatus determines that a value indicated by the parameter directive value adjustment complies with the parameter value constraint. The determination and the value may be similar as described regarding FIGS. 3A-3B, FIGS. 4A-4C, and FIGS. 5A-5C.

At block 710, the apparatus determines the parameter directive such that the parameter directive identifies the parameter directive type and the parameter directive value adjustment. The determination may be similar as described regarding FIGS. 3A-3B, FIGS. 4A-4C, and FIGS. 5A-5C.

At block 712, the apparatus causes the separate apparatus to configure the parameter by way of sending of the parameter directive to the separate apparatus. The sending of the parameter directive and the causation of configuration may be similar as described regarding FIG. 2, FIGS. 3A-3B, FIGS. 4A-4C, and FIGS. 5A-5C.

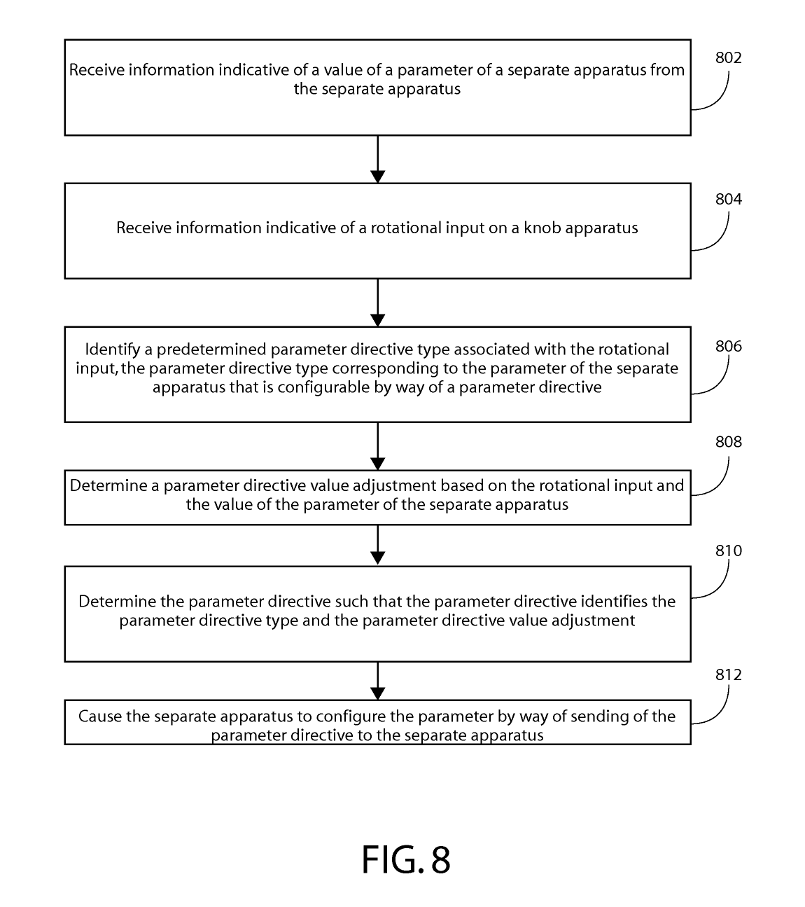

FIG. 8 is a flow diagram illustrating activities associated with causation of a separate apparatus to configure a parameter by way of sending of a parameter directive to the separate apparatus according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

As discussed previously, in many circumstances, it may be desirable to receive information indicative of a value of a parameter of a separate apparatus from the separate apparatus. In such circumstances, it may be desirable to determine a parameter directive value adjustment based, at least in part, on the value of the parameter of the separate apparatus.

At block 802, the apparatus receives information indicative of a value of a parameter of a separate apparatus from the separate apparatus. The receipt, the value, the parameter, and the separate apparatus may be similar as described regarding FIG. 2, FIGS. 3A-3B, FIGS. 4A-4C, and FIGS. 5A-5C.

At block 804, the apparatus receives information indicative of a rotational input on a knob apparatus. In at least one example embodiment, the knob apparatus is an apparatus that comprises a knob configured to receive a rotational input. The receipt, the rotational input, the knob apparatus, and the knob may be similar as described regarding FIG. 2, FIGS. 3A-3B, and FIGS. 5A-5C.

At block 806, the apparatus identifies a predetermined parameter directive type associated with the rotational input. In at least one example embodiment, the parameter directive type corresponds to the parameter of the separate apparatus that is configurable by way of a parameter directive. The identification, the parameter directive type, and the parameter directive may be similar as described regarding FIG. 2, FIGS. 3A-3B, FIGS. 4A-4C, and FIGS. 5A-5C.

At block 808, the apparatus determines a parameter directive value adjustment based, at least in part, on the rotational input and the value of the parameter of the separate apparatus. The determination and the parameter directive value adjustment may be similar as described regarding FIGS. 3A-3B, FIGS. 4A-4C, and FIGS. 5A-5C.

At block 810, the apparatus determines the parameter directive such that the parameter directive identifies the parameter directive type and the parameter directive value adjustment. The determination may be similar as described regarding FIGS. 3A-3B, FIGS. 4A-4C, and FIGS. 5A-5C.

At block 812, the apparatus causes the separate apparatus to configure the parameter by way of sending of the parameter directive to the separate apparatus. The sending of the parameter directive and the causation of configuration may be similar as described regarding FIG. 2, FIGS. 3A-3B, FIGS. 4A-4C, and FIGS. 5A-5C.

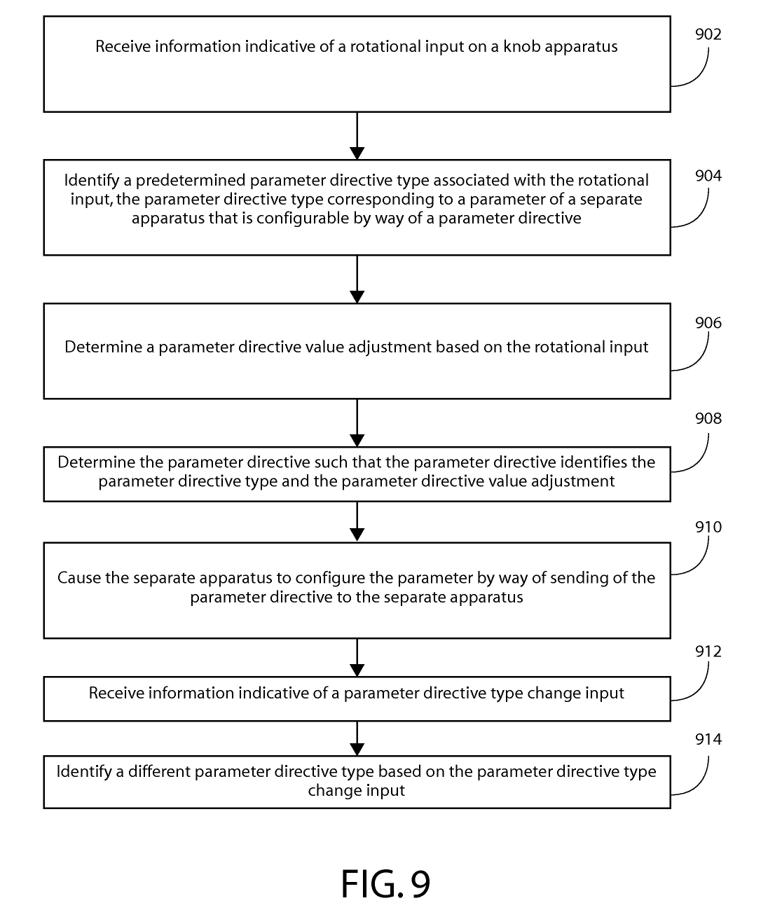

FIG. 9 is a flow diagram illustrating activities associated with identification of a different parameter directive type based, at least in part, on a parameter directive type change input according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

As discussed previously, in many circumstances, it may be desirable to identify a different parameter directive type based, at least in part, on a parameter directive type change input. For example, a user of an apparatus may indicate that the user desires to adjust a value associated with a temperate parameter of a separate apparatus by way of a rotational input such that the apparatus causes the separate apparatus to configure the temperature parameter by way of sending a parameter directive to the separate apparatus. Subsequently, the user may desire to adjust a different parameter associated with a different parameter type. As such, the user may indicate such a desire by way of a parameter directive type change input. In such an example, the user may then indicate that the user desires to adjust a value associated with a radio frequency parameter of a separate apparatus by way of a rotational input such that the apparatus causes the separate apparatus to configure the radio frequency parameter by way of sending another parameter directive to the separate apparatus.

At block 902, the apparatus receives information indicative of a rotational input on a knob apparatus. In at least one example embodiment, the knob apparatus is an apparatus that comprises a knob configured to receive a rotational input. The receipt, the rotational input, the knob apparatus, and the knob may be similar as described regarding FIG. 2, FIGS. 3A-3B, and FIGS. 5A-5C.

At block 904, the apparatus identifies a predetermined parameter directive type associated with the rotational input. In at least one example embodiment, the parameter directive type corresponds to a parameter of a separate apparatus that is configurable by way of a parameter directive. The identification, the parameter directive type, the parameter, the separate apparatus, and the parameter directive may be similar as described regarding FIG. 2, FIGS. 3A-3B, FIGS. 4A-4C, and FIGS. 5A-5C.

At block 906, the apparatus determines a parameter directive value adjustment based, at least in part, on the rotational input. The determination and the parameter directive value adjustment may be similar as described regarding FIGS. 3A-3B, FIGS. 4A-4C, and FIGS. 5A-5C.

At block 908, the apparatus determines the parameter directive such that the parameter directive identifies the parameter directive type and the parameter directive value adjustment. The determination may be similar as described regarding FIGS. 3A-3B, FIGS. 4A-4C, and FIGS. 5A-5C.

At block 910, the apparatus causes the separate apparatus to configure the parameter by way of sending of the parameter directive to the separate apparatus. The sending of the parameter directive and the causation of configuration may be similar as described regarding FIG. 2, FIGS. 3A-3B, FIGS. 4A-4C, and FIGS. 5A-5C.

At block 912, the apparatus receives information indicative of a parameter directive type change input. The receipt and the parameter directive type change input may be similar as described regarding FIG. 2, FIGS. 3A-3B, FIGS. 4A-4C, and FIGS. 5A-5C.

At block 914, the apparatus identifies a different parameter directive type based, at least in part, on the parameter directive type change input. The identification and the different parameter directive type may be similar as described regarding FIGS. 3A-3B, FIGS. 4A-4C, and FIGS. 5A-5C.

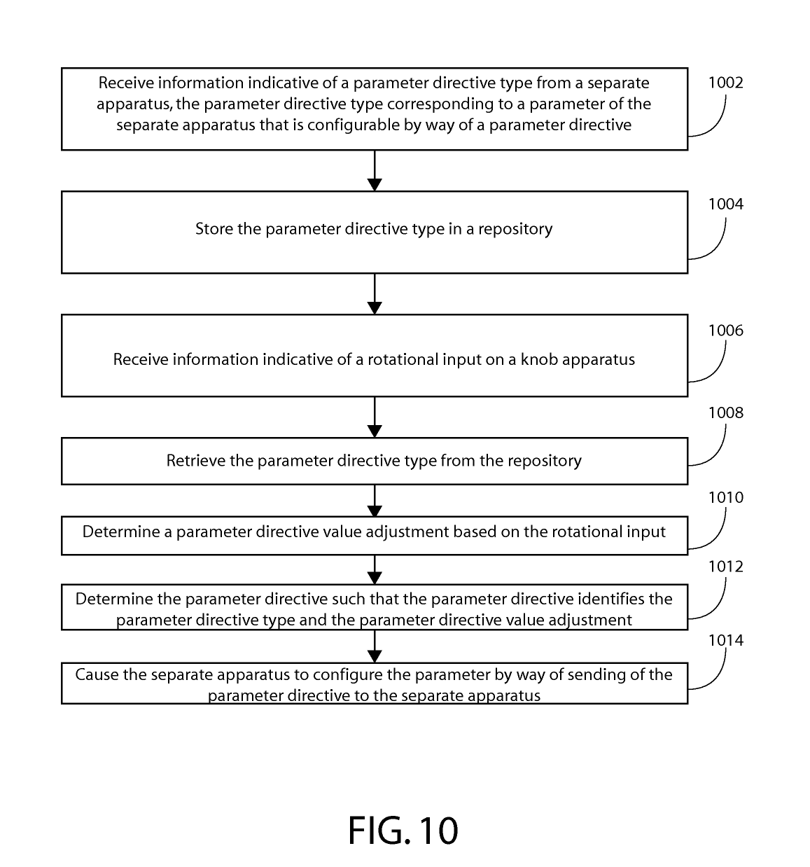

FIG. 10 is a flow diagram illustrating activities associated with causation of a separate apparatus to configure a parameter by way of sending of a parameter directive to the separate apparatus according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

As discussed previously, in many circumstances, it may be desirable to receive information indicative of a parameter directive type of a separate apparatus. In such circumstances, it may be desirable to store the parameter directive type in a repository.

At block 1002, the apparatus receives information indicative of a parameter directive type from a separate apparatus. In at least one example embodiment, the parameter directive type corresponds to a parameter of the separate apparatus that is configurable by way of a parameter directive. The receipt, the parameter, the parameter directive, the parameter directive type, and the separate apparatus may be similar as described regarding FIG. 2, FIGS. 3A-3B, FIGS. 4A-4C, and FIGS. 5A-5C.

At block 1004, the apparatus stores the parameter directive type in a repository. The storage of the parameter directive type and the repository may be similar as described regarding FIG. 2, FIGS. 4A-4C, and FIGS. 5A-5C.

At block 1006, the apparatus receives information indicative of a rotational input on a knob apparatus. In at least one example embodiment, the knob apparatus is an apparatus that comprises a knob configured to receive a rotational input. The receipt, the rotational input, the knob apparatus, and the knob may be similar as described regarding FIG. 2, FIGS. 3A-3B, and FIGS. 5A-5C.

At block 1008, the apparatus retrieves the parameter directive type from the repository. The retrieval of the parameter directive type may be similar as described regarding FIG. 2, FIGS. 3A-3B, and FIGS. 5A-5C.

At block 1010, the apparatus determines a parameter directive value adjustment based, at least in part, on the rotational input. The determination and the parameter directive value adjustment may be similar as described regarding FIGS. 3A-3B, FIGS. 4A-4C, and FIGS. 5A-5C.

At block 1012, the apparatus determines the parameter directive such that the parameter directive identifies the parameter directive type and the parameter directive value adjustment. The determination may be similar as described regarding FIGS. 3A-3B, FIGS. 4A-4C, and FIGS. 5A-5C.

At block 1014, the apparatus causes the separate apparatus to configure the parameter by way of sending of the parameter directive to the separate apparatus. The sending of the parameter directive and the causation of configuration may be similar as described regarding FIG. 2, FIGS. 3A-3B, FIGS. 4A-4C, and FIGS. 5A-5C.

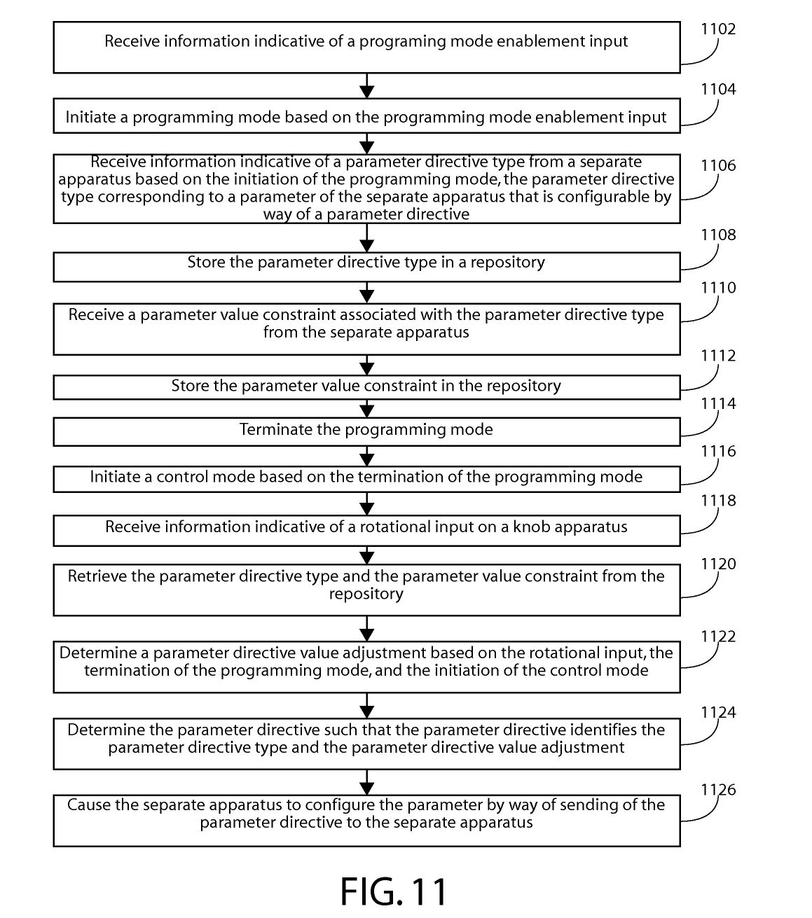

FIG. 11 is a flow diagram illustrating activities associated with causation of a separate apparatus to configure a parameter by way of sending of a parameter directive to the separate apparatus according to at least one example embodiment. In at least one example embodiment, there is a set of operations that corresponds with the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

As discussed previously, in many circumstances, it may be desirable to allow a user to program an apparatus by way of a programming mode, and/or to control an apparatus by way of a control mode.

At block 1102, the apparatus receives information indicative of a programming mode enablement input. The receipt and the programming mode enablement input may be similar as described regarding FIG. 2, FIGS. 4A-4C, and FIGS. 5A-5C.

At block 1104, the apparatus initiates a programming mode based, at least in part, on the programming mode enablement input. The initiation and the programming mode may be similar as described regarding FIGS. 4A-4C and FIGS. 5A-5C.

At block 1106, the apparatus receives information indicative of a parameter directive type of a separate apparatus based, at least in part, on the initiation of the programming mode. In at least one example embodiment, the parameter directive type corresponds to a parameter of the separate apparatus that is configurable by way of a parameter directive. The receipt, the parameter directive type, the separate apparatus, the parameter, and the parameter directive may be similar as described regarding FIG. 2, FIGS. 3A-3B, FIGS. 4A-4C, and FIGS. 5A-5C.

At block 1108, the apparatus stores the parameter directive type in a repository. The storage of the parameter directive type and the repository may be similar as described regarding FIG. 2, FIGS. 4A-4C, and FIGS. 5A-5C.

At block 1110, the apparatus receives a parameter value constraint associated with the parameter directive type from the separate apparatus. The receipt and the parameter value constraint may be similar as described regarding FIG. 2, FIGS. 4A-4C, and FIGS. 5A-5C.

At block 1112, the apparatus stores the parameter value constraint in the repository. In at least one example embodiment, the parameter value constraint is stored such that the parameter value constraint is associated with the parameter directive type. The storage of the parameter value constraint in the repository may be similar as described regarding FIG. 2, FIGS. 4A-4C, and FIGS. 5A-5C.

At block 1114, the apparatus terminates the programming mode. In at least one example embodiment, the termination of the programming mode may be similar as described regarding FIGS. 4A-4C and FIGS. 5A-5C.

At block 1116, the apparatus initiates a control mode based, at least in part, on the termination of the programming mode. The initiation and the control mode may be similar as described regarding FIGS. 4A-4C and FIGS. 5A-5C.

At block 1118, the apparatus receives information indicative of a rotational input on a knob apparatus. In at least one example embodiment, the knob apparatus is an apparatus that comprises a knob configured to receive a rotational input. The receipt, the rotational input, the knob apparatus, and the knob may be similar as described regarding FIG. 2, FIGS. 3A-3B, and FIGS. 5A-5C.

At block 1120, the apparatus retrieves the parameter directive type and the parameter value constraint from the repository. The retrieval of the parameter directive type and the parameter value constraint from the repository may be similar as described regarding FIG. 2, FIGS. 4A-4C, and FIGS. 5A-5C.

At block 1122, the apparatus determines a parameter directive value adjustment based, at least in part, on the rotational input. In at least one example embodiment, the determination of the parameter directive value adjustment based, at least in part, on the termination of the programming mode. In at least one example embodiment, the determination of the parameter directive value adjustment based, at least in part, on the initiation of the control mode. The determination and the parameter directive value adjustment may be similar as described regarding FIGS. 3A-3B, FIGS. 4A-4C, and FIGS. 5A-5C.

At block 1124, the apparatus determines the parameter directive such that the parameter directive identifies the parameter directive type and the parameter directive value adjustment. The determination may be similar as described regarding FIGS. 3A-3B, FIGS. 4A-4C, and FIGS. 5A-5C.

At block 1126, the apparatus causes the separate apparatus to configure the parameter by way of sending of the parameter directive to the separate apparatus. The sending of the parameter directive and the causation of configuration may be similar as described regarding FIG. 2, FIGS. 3A-3B, FIGS. 4A-4C, and FIGS. 5A-5C.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 912 and block 914 of FIG. 9 may be performed before block 902 of FIG. 9. Furthermore, if desired, one or more of the above-described functions may be optional or may be combined. For example, block 1116 of FIG. 11 may be optional and/or combined with block 1114 of FIG. 11.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

What is claimed is:

1. A knob apparatus, comprising:
at least one processor;
at least one memory including computer program code, the memory and the computer program code configured to, working with the processor, cause the apparatus to perform at least the following:
receipt of information indicative of a rotational input on the knob apparatus, the knob apparatus being an apparatus that comprises a knob configured to receive the rotational input;
identification of a predetermined parameter directive type associated with the rotational input, the parameter directive type corresponding to a parameter of a separate apparatus that is configurable by way of a parameter directive;
determination of a parameter directive value adjustment based, at least in part, on the rotational input;
determination of the parameter directive such that the parameter directive identifies the parameter directive type and the parameter directive value adjustment; and
causation of the separate apparatus to configure the parameter by way of sending of the parameter directive to the separate apparatus.

2. The knob apparatus of claim 1, wherein the knob apparatus comprises a housing and the knob, such that knob is a predominant physical aspect of the knob apparatus.

3. The knob apparatus of claim 1, wherein the parameter directive type is associated with a parameter value constraint, the parameter value constraint being indicative of at least one of a minimum allowable value or a maximum allowable value.

4. The knob apparatus of claim 1, wherein the parameter directive type indicates at least one of a volume parameter, a temperature parameter, a fan speed parameter, a channel selection parameter, a media item rendering position parameter, or a media item selection parameter.

5. The knob apparatus of claim 1, wherein the memory includes computer program code configured to, working with the processor, cause the apparatus to perform receipt of information indicative of a value of the parameter of the separate apparatus from the separate apparatus, wherein the determination of the parameter directive value adjustment is based, at least in part, on the value of the parameter of the separate apparatus.

6. The knob apparatus of claim 1, wherein the memory includes computer program code configured to, working with the processor, cause the apparatus to perform:
receipt of information indicative of a parameter directive type change input; and
identification of a different parameter directive type based, at least in part, on the parameter directive type change input.

7. The knob apparatus of claim 1, wherein the memory includes computer program code configured to, working with the processor, cause the apparatus to perform:
receipt of information indicative of the parameter directive type from the separate apparatus; and
storage of the parameter directive type in a repository, wherein the identification of the parameter directive type comprises retrieval of the parameter directive type from the repository.

8. The knob apparatus of claim 7, wherein the memory includes computer program code configured to, working with the processor, cause the apparatus to perform receipt of information indicative of a programming mode enablement input, wherein the receipt of the information indicative of the parameter directive type from the separate apparatus is based, at least in part, on the programming mode enablement input.

9. The apparatus of claim 1, wherein the knob apparatus comprises a display.

10. A method comprising:
receiving information indicative of a rotational input on a knob apparatus, the knob apparatus being an apparatus that comprises a knob configured to receive the rotational input;
identifying a predetermined parameter directive type associated with the rotational input, the parameter directive type corresponding to a parameter of a separate apparatus that is configurable by way of a parameter directive;
determining a parameter directive value adjustment based, at least in part, on the rotational input;
determining the parameter directive such that the parameter directive identifies the parameter directive type and the parameter directive value adjustment; and
causing the separate apparatus to configure the parameter by way of sending of the parameter directive to the separate apparatus.

11. The method of claim 10, wherein the parameter directive type is associated with a parameter value constraint, the parameter value constraint being indicative of at least one of a minimum allowable value or a maximum allowable value.

12. The method of claim 10, wherein the parameter directive type indicates at least one of a volume parameter, a temperature parameter, a fan speed parameter, a channel selection parameter, a media item rendering position parameter, or a media item selection parameter.

13. The method of claim 10, further comprising receiving information indicative of a value of the parameter of the separate apparatus from the separate apparatus, wherein the determination of the parameter directive value adjustment is based, at least in part, on the value of the parameter of the separate apparatus.

14. The method of claim 10, further comprising:
receiving information indicative of a parameter directive type change input; and
identifying a different parameter directive type based, at least in part, on the parameter directive type change input.

15. The method of claim 10, further comprising:
receiving information indicative of the parameter directive type from the separate apparatus; and
storing the parameter directive type in a repository, wherein the identification of the parameter directive type comprises retrieval of the parameter directive type from the repository.

16. The method of claim 15, further comprising receiving information indicative of a programming mode enablement input, wherein the receipt of the information indicative of the parameter directive type from the separate apparatus is based, at least in part, on the programming mode enablement input.

17. At least one computer-readable medium encoded with instructions that, when executed by a processor, perform:
receipt of information indicative of a rotational input on a knob apparatus, the knob apparatus being an apparatus that comprises a knob configured to receive the rotational input;
identification of a predetermined parameter directive type associated with the rotational input, the parameter directive type corresponding to a parameter of a separate apparatus that is configurable by way of a parameter directive;
determination of a parameter directive value adjustment based, at least in part, on the rotational input;
determination of the parameter directive such that the parameter directive identifies the parameter directive type and the parameter directive value adjustment; and
causation of the separate apparatus to configure the parameter by way of sending of the parameter directive to the separate apparatus.

18. The medium of claim 17, further encoded with instructions that, when executed by a processor, perform receipt of information indicative of a value of the parameter of the separate apparatus from the separate apparatus, wherein the determination of the parameter directive value adjustment is based, at least in part, on the value of the parameter of the separate apparatus.

19. The medium of claim 17, further encoded with instructions that, when executed by a processor, perform:
receipt of information indicative of a parameter directive type change input; and
identification of a different parameter directive type based, at least in part, on the parameter directive type change input.

20. The medium of claim 17, further encoded with instructions that, when executed by a processor, perform:
receipt of information indicative of the parameter directive type from the separate apparatus; and
storage of the parameter directive type in a repository, wherein the identification of the parameter directive type comprises retrieval of the parameter directive type from the repository.
